(19) United States
(12) Patent Application Publication
(10) Pub. No.: US 2026/0264131 A1
(43) Pub. Date: Sep. 10, 2026

(54) PUNCH PRESS DIE-CLOSING ADJUSTMENT MECHANISM

(71) Applicant: National Kaohsiung University of Science and Technology, Kaohsiung City (TW)

(72) Inventors: CHUN-CHIH KUO, Kaohsiung City (TW); Bor-Tsuen Lin, Kaohsiung City (TW); Chai-Hung Chang, Kaohsiung City (TW); Wan-Ting Chao, Kaohsiung City (TW)

(21) Appl. No.: 19/553,697

(22) Filed: Mar. 2, 2026

(30) Foreign Application Priority Data
Mar. 7, 2025 (TW) 114108570

(51) Int. Cl. B21D 28/34

(52) U.S. Cl. CPC B21D 28/34

(57) ABSTRACT

A punch press die-closing adjustment mechanism includes: a power transmission mechanism, driving a rotating shaft by a power source to rotate to provide power output; an eccentric wheel mechanism, fixedly provided with an eccentric wheel on the rotating shaft respectively to generate eccentric motion; a yoke box supporting mechanism, including an upper sliding block, a lower sliding block and a sliding block box, where the upper sliding block and the lower sliding block are arranged in the sliding block box and pivoted to eccentric wheels, a first sliding block of the yoke box supporting mechanism is driven to perform a linear lifting sliding movement, and the first sliding block is connected to a shaft rod; and a punch group, where a punch is pivotally connected to the shaft rod to drive the punch to perform a reciprocating linear lifting movement.

### TECHNICAL FIELD

The present invention relates to a die-closing height adjustment mechanism, and in particular to a technical solution for improving punch press die-closing precision and stability by applying a Scottish yoke mechanism.

### BACKGROUND

The development of industrial technology is devoted to the breakthrough and improvement of the technical level, so as to improve the precision and quality requirements of products. As far as the manufacturing of mechanical components and hardware parts widely used in hand tools or motorcycles at present is concerned, most of them use forging and punching technology to achieve the purpose of forming. Therefore, how to make the finished products meet the requirements of precision is the focus and pursuit goal of the industry to develop punch press machinery.

A punch press is equipment commonly used in metal forming and punching, and the motion control and machining precision of the punch press directly affect the product quality. Most of the existing punch presses achieve height change of a die-closing height by adjusting the length of a connecting rod and through a crank connecting rod mechanism, but this adjustment method will affect the motion track of a servo punch press in practical application. When the length of the connecting rod changes, the motion modes of the servo punch press, such as pulse and inching, will change with the change of the die-closing height, so that motion compensation is required in the machining process to maintain the stability of the motion track.

### SUMMARY

The present invention provides a punch press die-closing adjustment mechanism, which adjusts a die-closing height by using a Scottish yoke mechanism, thereby effectively improving the machining precision and motion stability of a servo punch press.

The punch press die-closing adjustment mechanism provided by the present invention includes: a power transmission mechanism, driving a rotating shaft by a power source to rotate; an eccentric wheel mechanism, fixedly provided with an eccentric wheel on the rotating shaft, respectively; a yoke box supporting mechanism, comprising an upper sliding block, a lower sliding block and a sliding block box, where the upper sliding block and the lower sliding block are arranged in the sliding block box and pivoted to eccentric wheels, a first sliding block of the yoke box supporting mechanism is driven to perform a linear lifting sliding movement, and the first sliding block is connected to a shaft rod; and a punch group, where a punch is pivotally connected to the shaft rod to drive the punch to perform a reciprocating linear lifting movement.

In one embodiment of the present invention, the power source is a motor.

In one embodiment of the present invention, the power transmission mechanism is provided with the motor on a machine frame, the rotating shaft is mounted on the machine frame, a flywheel is mounted at one end of the rotating shaft, and the motor drives the flywheel by a belt to drive the rotating shaft to rotate.

In one embodiment of the present invention, the eccentric wheel mechanism is a camshaft mechanism.

In one embodiment of the present invention, outer sides of the upper sliding block and the lower sliding block are in contact with an inner wall of a window portion of the sliding block box, respectively.

In one embodiment of the present invention, inner sides of the upper sliding block and the lower sliding block slidingly support, in a circumferential direction, the eccentric wheel mechanism eccentrically mounted on the rotating shaft, respectively.

In one embodiment of the present invention, the yoke box supporting mechanism further includes a guide rail group, so that the first sliding block slides on a guide rail to adjust a relative distance between the yoke box supporting mechanism and the punch group.

In one embodiment of the present invention, through a Scottish yoke mechanism formed together with the eccentric wheel mechanism, the yoke box supporting mechanism enables the first sliding block to move between a top dead center and a bottom dead center.

In one embodiment of the present invention, the yoke box supporting mechanism adjusts a die-closing height through the position of the bottom dead center.

In one embodiment of the present invention, according to the yoke box supporting mechanism, the adjustment range is 0 mm to 100 mm, and the adjustment precision is 0.01 mm.

According to the present invention, by virtue of an adjustable yoke box supporting system, the adjustable yoke box supporting system adjusts a distance between the yoke box and the punch to achieve the change of the die-closing height. Furthermore, the Scottish yoke only shifts the positions of the top dead center and the bottom dead center without changing the waveform of the displacement. Therefore, compared with the traditional crank connecting rod which has an acceleration that tends to be gentle at the position close to the bottom dead center and has an acceleration in a negative direction when the die-closing height is adjusted, which means that the crank connecting rod mechanism will have hysteresis when approaching the bottom dead center, resulting in mechanism vibration, the acceleration change of the Scottish yoke still shows a sine wave change, the displacement control is more accurate when the servo punch press repeatedly moves (such as a vibration curve and a bottom dead center forging curve), the motion track is not affected by the change of mechanism parameters, and the simplification of controller compensation is facilitated.

### BRIEF DESCRIPTION OF THE DRAWINGS

FIG. 1 is a schematic diagram of the appearance of a punch press die-closing adjustment mechanism according to the present invention;

FIG. 2 is a schematic diagram of the movement of a Scottish yoke mechanism of a punch press die-closing adjustment mechanism according to the present invention;

FIG. 3 is a schematic diagram of a displacement curve of a punch press die-closing adjustment mechanism according to the present invention; and

FIG. 4 is a schematic diagram of an acceleration curve of a punch press die-closing adjustment mechanism according to the present invention.

### DETAILED DESCRIPTION OF THE EMBODIMENTS

To make the above features and advantages of the present invention more obvious and understandable, the following will describe in detail by giving embodiments and with reference to the accompanying drawings.

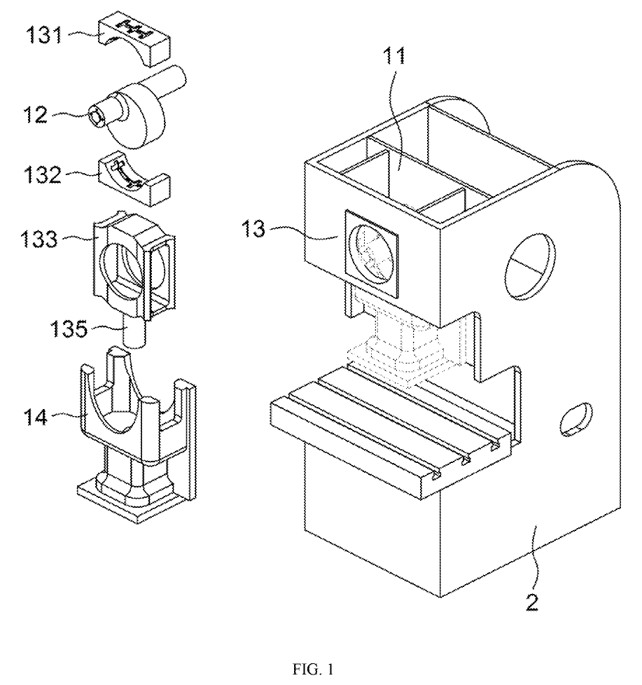

FIG. 1 is a schematic diagram of the appearance of a punch press die-closing adjustment mechanism according to the present invention. In FIG. 1, a punch press die-closing adjustment mechanism includes: a power transmission mechanism 11, driving a rotating shaft by a power source to rotate; an eccentric wheel mechanism 12, fixedly provided with an eccentric wheel on the rotating shaft, respectively; a yoke box supporting mechanism 13, including an upper sliding block 131, a lower sliding block 132 and a sliding block box 133, where the upper sliding block 131 and the lower sliding block 132 are arranged in the sliding block box 133 and pivoted to eccentric wheels, a first sliding block of the yoke box supporting mechanism 13 is driven to perform a linear lifting sliding movement, and the first sliding block is connected to a shaft rod 135; and a punch group 14, where a punch is pivotally connected to the shaft rod 135 to drive the punch to perform a reciprocating linear lifting movement.

In this embodiment, the power source is a motor.

The power transmission mechanism 11 is provided with the motor above a machine frame 2, the rotating shaft is mounted on the machine frame 2, a flywheel is mounted at one end of the rotating shaft, and the motor drives the flywheel by a belt to drive the rotating shaft to rotate.

In this embodiment, the eccentric wheel mechanism 12 is a camshaft mechanism.

In this embodiment, outer sides of the upper sliding block 131 and the lower sliding block 132 in the yoke box supporting mechanism 13 are in contact with an inner wall of a window portion of the sliding block box 133, respectively.

In this embodiment, inner sides of the upper sliding block 131 and the lower sliding block 132 slidingly support, in a circumferential direction, the eccentric wheel mechanism 12 eccentrically mounted on the rotating shaft, respectively.

In this embodiment, the yoke box supporting mechanism 13 further includes a guide rail group, so that the first sliding block slides on a guide rail to adjust a relative distance between the yoke box supporting mechanism 13 and the punch group 14.

The first sliding block is driven by the motor to slide on the guide rail so as to adjust a relative distance between the sliding block box 133 and the punch.

In this embodiment, through a Scottish yoke mechanism formed together with the eccentric wheel mechanism 12, the yoke box supporting mechanism 13 enables the first sliding block to move between a top dead center and a bottom dead center.

The yoke box supporting mechanism 13 adjusts a die-closing height through the position of the bottom dead center.

According to the yoke box supporting mechanism 13, the adjustment range is 0 mm to 100 mm, and the adjustment precision is 0.01 mm, so that the servo punch press can adapt to more different machining requirements.

In this embodiment, it can be ensured that when the servo punch press adjusts the die-closing height, the motion track is kept stable and the motion requirements of motion modes such as pulse and inching are met.

The Scottish yoke mechanism only shifts the positions of the top dead center and the bottom dead center without changing the waveform of the displacement. Therefore, compared with the crank connecting rod, when the die-closing height is adjusted, the motion track is not affected by the change of mechanism parameters, and the simplification of controller compensation is facilitated.

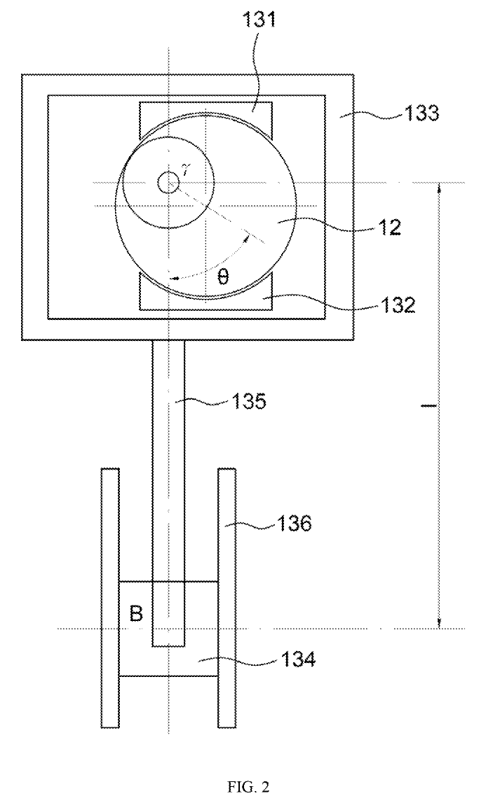

FIG. 2 is a schematic diagram of the movement of a Scottish yoke mechanism of a punch press die-closing adjustment mechanism according to the present invention. In FIG. 2, the eccentric wheel mechanism 12 performs revolution movement along a circular orbit centered on the rotating shaft of the motor, is in contact with the upper sliding block 131 and the lower sliding block 132 of the eccentric wheel mechanism 12 due to the eccentric structure, and performs reciprocating movement in the sliding block box 133 in a left-right direction.

Furthermore, due to the eccentric structure of the eccentric wheel mechanism 12, the first sliding block 134 of the shaft rod 135 performs up-and-down reciprocating movement so as to drive the punch group 14 to move.

In this embodiment, outer sides of the upper sliding block 131 and the lower sliding block 132 in the yoke box supporting mechanism 13 are in contact with an inner wall of a window portion of the sliding block box 133, respectively.

In this embodiment, inner sides of the upper sliding block 131 and the lower sliding block 132 slidingly support, in a circumferential direction, the eccentric wheel mechanism 12 eccentrically mounted on the rotating shaft, respectively.

In this embodiment, the yoke box supporting mechanism 13 further includes a guide rail group 136, so that the first sliding block 134 slides on a guide rail to adjust a relative distance between the yoke box supporting mechanism 13 and the punch group 14.

The first sliding block 134 is driven by the motor to slide on the guide rail so as to adjust a relative distance between the sliding block box 133 and the punch.

In this embodiment, through the Scottish yoke mechanism formed together with the eccentric wheel mechanism 12, the yoke box supporting mechanism 13 enables the first sliding block 134 to move between a top dead center and a bottom dead center.

The yoke box supporting mechanism 13 adjusts a die-closing height through the position of the bottom dead center.

According to the yoke box supporting mechanism 13, the adjustment range is 0 mm to 100 mm, and the adjustment precision is 0.01 mm, so that the servo punch press can adapt to more different machining requirements.

In this embodiment, it can be ensured that when the servo punch press adjusts the die-closing height, the motion track is kept stable and the motion requirements of motion modes such as pulse and inching are met.

The Scottish yoke mechanism only shifts the positions of the top dead center and the bottom dead center without changing the waveform of the displacement. Therefore, compared with the crank connecting rod, when the die-closing height is adjusted, the motion track is not affected by the change of mechanism parameters, and the simplification of controller compensation is facilitated.

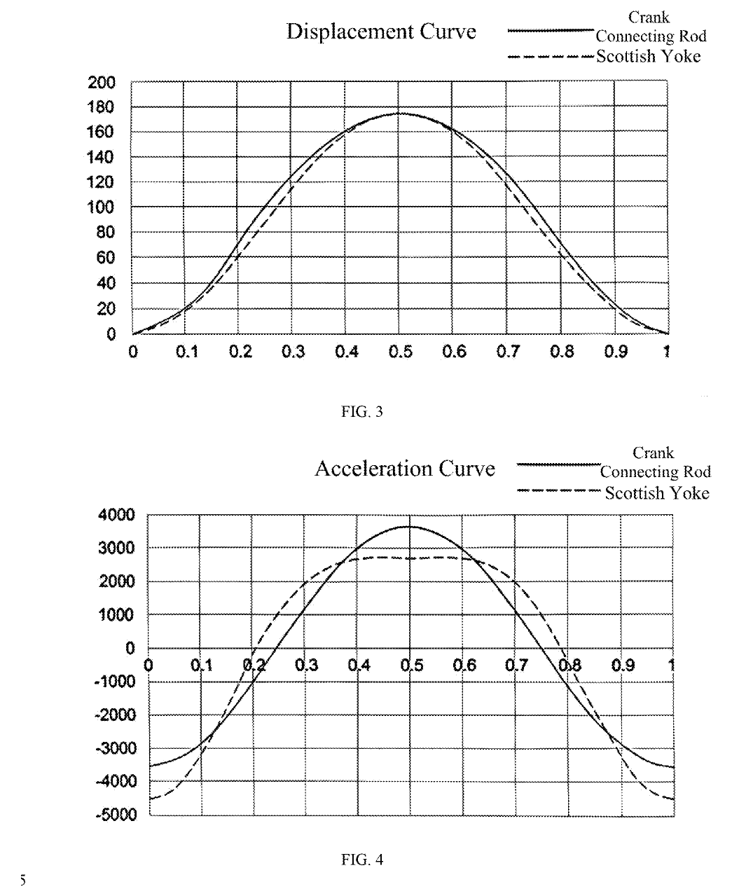

Referring to both FIG. 3 and FIG. 4, FIG. 3 is a schematic diagram of a displacement curve of a punch press die-closing adjustment mechanism according to the present invention; and FIG. 4 is a schematic diagram of an acceleration curve of a punch press die-closing adjustment mechanism according to the present invention.

In this embodiment, in the punch press, it is often necessary to adjust the die-closing height. For the punch press using the typical crank connecting rod mechanism, the die-closing height position at the bottom dead center is adjusted by adjusting the length of the connecting rod, but for the length adjustment of the connecting rod, the displacement waveform of the crank connecting rod mechanism will change accordingly. However, the Scottish yoke mechanism only shifts the positions of the top dead center and the bottom dead center without changing the waveform of the displacement. Therefore, compared with the crank connecting rod mechanism, when the die-closing height is adjusted, the motion track is not affected by the change of mechanism parameters, and the simplification of controller compensation is facilitated.

In this embodiment, the crank connecting rod mechanism has an acceleration that tends to be gentle at the position close to the bottom dead center and has an acceleration in a negative direction, which means that the crank connecting rod mechanism will have hysteresis when approaching the bottom dead center, resulting in mechanism vibration. The acceleration change of the Scottish yoke mechanism still shows a sine wave change, the displacement control is more accurate when the servo punch press repeatedly moves, such as a vibration curve and a bottom dead center forging curve.

In conclusion, according to the punch press die-closing adjustment mechanism provided by the present invention, by virtue of an adjustable yoke box supporting system, the adjustable yoke box supporting system adjusts a distance between the yoke box and the punch to achieve the change of the die-closing height. Furthermore, the Scottish yoke only shifts the positions of the top dead center and the bottom dead center without changing the waveform of the displacement. Therefore, compared with the traditional crank connecting rod which has an acceleration that tends to be gentle at the position close to the bottom dead center and has an acceleration in a negative direction when the die-closing height is adjusted, which means that the crank connecting rod mechanism will have hysteresis when approaching the bottom dead center, resulting in mechanism vibration, the acceleration change of the Scottish yoke still shows a sine wave change, the displacement control is more accurate when the servo punch press repeatedly moves (such as a vibration curve and a bottom dead center forging curve), the motion track is not affected by the change of mechanism parameters, and the simplification of controller compensation is facilitated.

Although the present invention has been disclosed above with reference to the foregoing embodiments, they are not intended to limit the present invention. Any equivalent substitutions made by those skilled in the art without departing from the spirit and scope of the present invention, including alterations and modifications, shall still be within the protection scope of the present invention.

What is claimed is:

1. A punch press die-closing adjustment mechanism, comprising:
a power transmission mechanism, driving a rotating shaft by a power source to rotate to provide power output;
an eccentric wheel mechanism, fixedly provided with an eccentric wheel on the rotating shaft, respectively;
a yoke box supporting mechanism, comprising an upper sliding block, a lower sliding block and a sliding block box, wherein the upper sliding block and the lower sliding block are arranged in the sliding block box and pivoted to eccentric wheels, a first sliding block of the yoke box supporting mechanism is driven to perform a linear lifting sliding movement, and the first sliding block is connected to a shaft rod; and
a punch group, wherein a punch is pivotally connected to the shaft rod to drive the punch to perform a reciprocating linear lifting movement.

2. The punch press die-closing adjustment mechanism according to claim 1, wherein the power source is a motor.

3. The punch press die-closing adjustment mechanism according to claim 2, wherein the power transmission mechanism is provided with the motor above a machine frame, the rotating shaft is mounted on the machine frame, a flywheel is mounted at one end of the rotating shaft, and the motor drives the flywheel by a belt to drive the rotating shaft to rotate.

4. The punch press die-closing adjustment mechanism according to claim 1, wherein the eccentric wheel mechanism is a camshaft mechanism.

5. The punch press die-closing adjustment mechanism according to claim 1, wherein outer sides of the upper sliding block and the lower sliding block in the yoke box supporting mechanism are in contact with an inner wall of a window portion of the sliding block box, respectively.

6. The punch press die-closing adjustment mechanism according to claim 1, wherein inner sides of the upper sliding block and the lower sliding block slidingly support, in a circumferential direction, the eccentric wheel mechanism eccentrically mounted on the rotating shaft, respectively.

7. The punch press die-closing adjustment mechanism according to claim 1, wherein the yoke box supporting mechanism further comprises a guide rail group, so that the first sliding block slides on a guide rail to adjust a relative distance between the yoke box supporting mechanism and the punch group.

8. The punch press die-closing adjustment mechanism according to claim 1, wherein through a Scottish yoke mechanism formed together with the eccentric wheel mechanism, the yoke box supporting mechanism enables the first sliding block to move between a top dead center and a bottom dead center.

9. The punch press die-closing adjustment mechanism according to claim 8, wherein the yoke box supporting mechanism adjusts a die-closing height through the position of the bottom dead center.

10. The punch press die-closing adjustment mechanism according to claim 8, wherein according to the yoke box supporting mechanism, the adjustment range is 0 mm to 100 mm, and the adjustment precision is 0.01 mm.
